(19) United States
(12) Patent Application Publication
(10) Pub. No.: US 2017/0364094 A1
(43) Pub. Date: Dec. 21, 2017

(54) METHOD, APPARATUS FOR CONTROLLING VIDEO SHOOTING AND UNMANNED AERIAL VEHICLE

(71) Applicant: ZEROTECH (Beijing) Intelligence Technology Co., Ltd., Beijing (CN)

(72) Inventors: Jianjun YANG, Beijing (CN); Lin YANG, Beijing (CN)

(21) Appl. No.: 15/607,429

(22) Filed: May 26, 2017

(30) Foreign Application Priority Data
Jun. 20, 2016 (CN) 201610448086.3

(51) Int. Cl. G05D 1/10; G03B 15/00; G05D 1/00; H04N 5/225

(52) U.S. Cl. CPC G05D 1/101; H04N 5/2251; G03B 15/006; G05D 1/0011; G05D 1/0094

(57) ABSTRACT

The present disclosure proposes a method and an apparatus for controlling video shooting and an unmanned aerial vehicle. The method for controlling video shooting includes: receiving a triggering instruction; responding to the triggering instruction so as to control an UAV to enter into an automatic shooting mode; and generating flight route information corresponding to a predetermined shooting pattern under the automatic shooting mode; controlling the UAV to fly according to the flight route information, and controlling a video shooting apparatus provided on the UAV to shoot under the predetermined shooting pattern while the UAV is flying according to the flight route information. The method, the apparatus and the unmanned aerial vehicle proposed by the present disclosure enable manual operations to be omitted during shooting, so that the shooting performed by the UAV will be fully automatic, upgrading user experience.

### CROSS-REFERENCE TO RELATED APPLICATIONS

This application claims priority to Chinese patent application No. 201610448086.3 filed on Jun. 20, 2016, the entire contents of which are incorporated herein by reference.

### TECHNICAL FIELD

The present disclosure generally relates to a method and an apparatus for controlling video shooting and an unmanned aerial vehicle (UAV).

### BACKGROUND

In relevant arts, video shooting using unmanned aerial vehicles (UAVs) is usually conducted manually. An UAV operator needs to activate the recording function of the camera first, and then operates manually to control the position of the UAV and the platform, so as to secure the orientation and the path of the camera during shooting. Manual operation requires skilled manipulation of the UAV, which is relatively complicated. Also, for certain basic recording methods, such as lens processing, repetition of the same operation each and every time will degrade user experience.

In certain circumstances, UAVs have limited time and opportunity to capture a video clip. Operational errors will lead to recording failure, causing huge loss.

### SUMMARY

The purpose of the present disclosure is to propose a method and an apparatus for controlling video shooting and an unmanned aerial vehicle, so as to make video shooting performed by an UAV more convenient and user-friendly.

In order to achieve the above-mentioned purpose, the present disclosure proposes the following technical solutions:

According to a first aspect of the present disclosure, it proposes an apparatus for controlling video shooting. The apparatus includes: a receiving module configured to receive a triggering instruction; a control module configured to control a UAV to enter into an automatic shooting mode in response to the triggering instruction; and a flight route generating module configured to generate flight route information corresponding to a predetermined shooting pattern under the automatic shooting mode; the control module is further configured to control the UAV to fly according to the flight route information, and control a video shooting apparatus provided on the UAV to shoot under the predetermined shooting pattern while the UAV is flying according to the flight route information.

According to a second aspect of the present disclosure, it proposes a method for controlling video shooting. The method includes: receiving a triggering instruction; controlling an UAV to enter into an automatic shooting mode in response to the triggering instruction; generating flight route information corresponding to a predetermined shooting pattern under the automatic shooting mode; controlling the UAV to fly according to the flight route information, and controlling a video shooting apparatus provided on the UAV to shoot under the predetermined shooting pattern while the UAV is flying according to the flight route information.

According to a third aspect of the present disclosure, it proposes an unmanned aerial vehicle (UAV). The UAV includes: a memory; a processor; and an apparatus for controlling video shooting, wherein said apparatus for controlling video shooting is loaded into the memory and includes one or more software function modules executed by the processor, wherein said apparatus for controlling video shooting includes: a receiving module configured to receive a triggering instruction; a control module configured to control the UAV to enter into an automatic shooting mode in response to the triggering instruction; and a flight route generating module configured to generate flight route information corresponding to a predetermined shooting pattern under the automatic shooting mode; the control module is further configured to control the UAV to fly according to the flight route information, and control a video shooting apparatus provided on the UAV to shoot under the predetermined shooting pattern while the UAV is flying according to the flight route information.

According to the method and the apparatus for controlling video shooting and the unmanned aerial vehicle proposed by the present disclosure, the UAV may enter into an automatic shooting mode upon receiving a triggering instruction, and generate flight route information corresponding to a predetermined shooting pattern under the automatic shooting mode. Then, the UAV will fly and perform shooting according to the flight route information. In this way, manual operations may be omitted during shooting so that shooting process will be fully automatic, upgrading user experience.

It is to be understood that both the foregoing general description and the following detailed description are exemplary and explanatory only, and are not restrictive of the invention. Further, the accompanying drawings, which are incorporated and constitute part of this specification, illustrate embodiments of the invention and together with the description, serve to explain principles of the invention.

### BRIEF DESCRIPTION OF THE DRAWINGS

In order to illustrate the solutions of embodiments of the present disclosure more clearly, the drawings used in connection with the embodiments will be briefly described below. It should be understood that the following drawings illustrate only certain embodiments of the present disclosure, and the scope of the present disclosure is not limited thereto. It should also be understood that other related drawings may be obtained by those skilled in the art from the drawings without departing the scope of the present disclosure.

FIG. 1 is a block diagram showing an exemplary UAV according to an embodiment of the present disclosure;

FIG. 2 is a block diagram showing the function modules of an exemplary apparatus for controlling video shooting according to an embodiment of the present disclosure;

FIG. 3 is a flow chart of an exemplary method for controlling video shooting according to an embodiment of the present disclosure;

FIG. 4A-4D are flow charts showing several possible situations in an exemplary method for controlling video shooting according to an embodiment of the present disclosure;

FIG. 5 is a schematic diagram showing an exemplary video shooting scenario under straight long shot pattern according to an embodiment the present disclosure.

### DETAILED DESCRIPTION OF THE PREFERRED EMBODIMENTS

Embodiments of the disclosure will be described, by way of example only, with reference to the accompanying drawings. The described embodiments are only a part of the embodiments of the present disclosure, but not all of the embodiments. The components of embodiments of the present disclosure, which are generally described and illustrated in the accompanying drawings, may be arranged and designed in a variety of different configurations. Accordingly, the following detailed description of embodiments of the disclosure provided in the drawings is not intended to limit the scope of the claimed disclosure, but merely to indicate selected embodiments of the disclosure. All other embodiments obtained by those skilled in the art without inventive effort are within the scope of the present disclosure.

It should be noted that same reference numbers will be used throughout the drawings to refer to the same or like parts. Thus, once an item is defined in a drawing, it is not necessary to define and explain it in subsequent drawings. It should be noted that relational terms, such as first and second, are used solely to separate one entity from another, and do not necessarily require or imply that one entity is more important than the other.

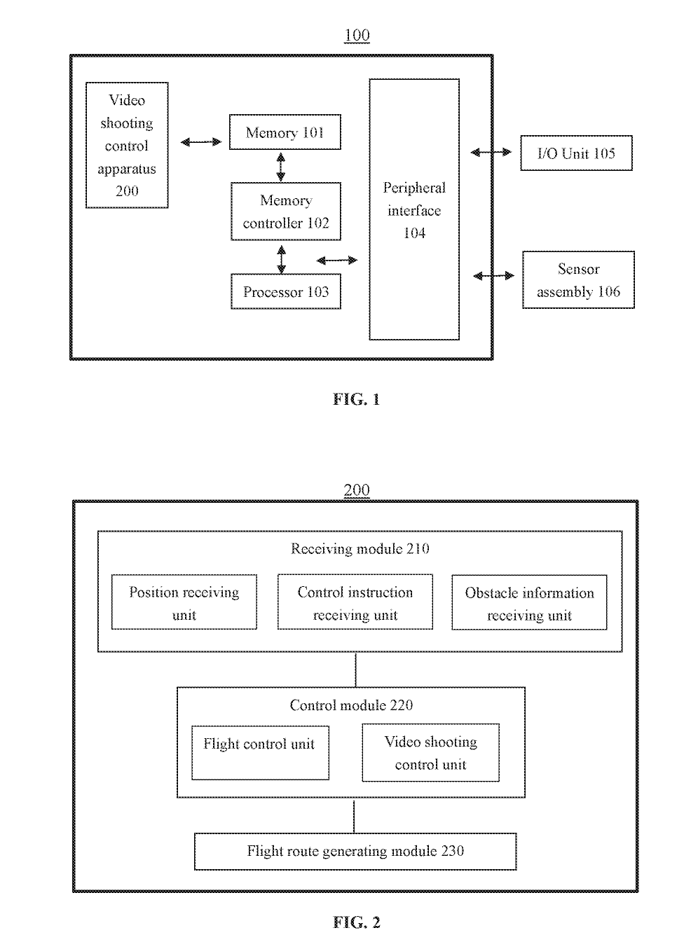

FIG. 1 is a block diagram showing an exemplary UAV 100 according to an embodiment of the present disclosure.

As shown in FIG. 1, the UAV 100 includes an apparatus for controlling video shooting 200, a memory 101, a memory controller 102, a processor 103, a peripheral interface 104, an input and output (I/O) unit 105 and a sensor assembly 106. The memory 101, the memory controller 102, the processor 103, the peripheral interface 104, the input and output (I/O) unit 105 and the sensor assembly 106 are electrically connected to each other directly or indirectly, so as to achieve data transmission or exchange. For example, these elements may be electrically connected to each other via one or more communication buses or signal lines. The apparatus for controlling video shooting 200 may include at least one software function module in the form of software or firmware stored in the memory 101. The processor 103 is used for executing the modules stored in the memory 101, such as software function modules or computer programs included in the apparatus for controlling video shooting 200. After receiving the execution instruction, the processor 220 executes the programs included in the memory 101.

The memory 101 is used for storing various types of programs. The memory 101 may be, but not limited to, random access memory 101 (RAM), read only memory 101 (ROM), programmable read-only memory 101 (PROM), erasable read only memory 101 (EPROM), electrically erasable read only memory 101 (EEPROM) and the like.

The processor 103 may be an integrated circuit chip with signal processing capability. The processor 103 as described may be a general purpose processor, including a central processor (CPU), a network processor (NP). The processor 103 can also be a digital signal processor (DSP), an application specific integrated circuit (ASIC), a field-programmable gate array (FPGA) or other programmable logic apparatus, discrete gate or transistor logic, discrete hardware components. The processor 103 can execute or implement methods, steps and logic diagrams disclosed in embodiments of the present disclosure. The processor 103 may be a microprocessor or any conventional processor, etc.

The peripheral interface 104 couples the I/O unit to the processor 103 and the memory 101. The peripheral interface 104, the processor 103 and the memory controller 102 may be realized in a single chip, or in separate chips.

The I/O unit 105 is used for providing input data to the user, so as to achieve interactions between the user and the UAV 100. The I/O unit 105 may be, but not limited to button, which is used for responding to the user's operation and outputting corresponding signal.

The sensor assembly 106 is used for responding to the user's operation and outputting corresponding signal. The sensor assembly 106 may be, but not limited to, GPS sensor, optical flow sensor, ultrasonic sensor, acoustic control sensor, acceleration sensor, barometer, Inertial Measurement Unit (IMU) and the like

It should be noted that the structure shown in FIG. 1 is illustrative only, the UAV 100 may have more or fewer components than those shown in FIG. 1, or may have different configuration as that shown in FIG. 1. Each of the components shown in FIG. 1 can be realized by hardware, software or a combination thereof.

### Embodiment 1

FIG. 2 is a block diagram showing the function modules of an apparatus for controlling video shooting 200 according to an embodiment of the present disclosure.

As shown in FIG. 2, the apparatus 200 may include a receiving module 210, a control module 220 and a flight route generating module 230.

The receiving module 210 is configured to receive a triggering instruction.

In this embodiment, the user sets in advance a predetermined shooting pattern for the UAV 100 via a remote control terminal, such as a UAV general purpose remote controller or a smartphone. This predetermined shooting pattern may be straight long shot, circling shooting around a point of interest (also referred as “POI circling shooting”), shooting under acceleration (also referred as “acceleration shooting”), shooting with the camera and the horizontal plane in a predetermined angle (also referred as “preset angle shooting) and the like.

When shooting under the straight long shot pattern, the UAV will fly along a straight line and the camera will continuously shoot for a relatively long period, forming a relatively complete video clip. When shooting under the circling shooting pattern, the UAV will fly along a circle centered on the point of interest (e.g., chosen by a user) while the camera performs shooting. When shooting under acceleration, the UAV will accelerate under a predetermined acceleration while the camera performs shooting. When shooting with the camera and the horizontal plane in a predetermined angle, the camera will be in a predetermined angle with the horizontal plane while performing shooting.

It should be noted that the predetermined shooting pattern may be set according to actual needs, and is not limited by the present disclosure.

After setting a predetermined shooting pattern for the UAV 100, the UAV 100 may be positioned in a predetermined height to facilitate shooting via a remote control terminal. For example, the UAV 100 may be positioned in a height flushed with the user's head or 2 meters away from the ground. The UAV 100 may also be controlled in hover state, so as to be prepared for shooting.

Then, the user may send a triggering instruction, which enables the UAV 100 to enter into an automatic shooting mode. In the automatic shooting mode, the UAV 100 will shoot according to the predetermined shooting pattern. The triggering instruction may be input by the user triggering a button on the remote control terminal, sending a voice command, or performing a specific gesture. The input method of the triggering instruction is not limited by the present disclosure.

When the user triggers a button to input the triggering instruction, the triggering instruction will be sent to the UAV 100 in signal form via a wireless network and received by an antenna mounted on the UAV 100. When the user sends a voice command, such as “automatic shooting” to input the triggering instruction, the voice command will be received by the UAV 100 as triggering instruction via an acoustic control sensor. When the user performs a specific gesture, such as waving up and down to input the triggering instruction, the gesture will be received by the UAV 100 as triggering instruction via an image capture apparatus. The gesture may also be converted into a triggering command via a remote controller, and the triggering command will then be sent to the UAV 100. In these embodiments, the antenna, the acoustic control sensor and the image capture apparatus will send the triggering instruction to the receiving module 210, and the receiving module 210 will send the triggering instruction to the control module 220.

In some embodiments, the UAV may have a plurality of predetermined shooting patterns. In this situation, the user may need to send in advance an instruction for setting a specific predetermined shooting pattern to the UAV via a remote control terminal. For example, if an UAV may perform straight long shot and circling shooting around a point of interest, the user may send an instruction setting the straight long shot pattern and circling shooting around a point of interest pattern as the predetermined shooting pattern for the UAV. The UAV will then respond to the triggering instruction.

In other embodiments, the UAV may have only one predetermined shooting pattern. In this situation, the user does not need to send an instruction used for setting the predetermined shooting pattern for the UAV. Instead, the predetermined shooting pattern is already installed in the UAV in advance.

It should be noted that the predetermined height and the flying or shooting mode before receiving a triggering instruction of the UAV 100 are not limited by the embodiments of the present disclosure. The UAV 100 may receive a triggering instruction in any height or under any flying or shooting mode. If the UAV is in other flying or shooting mode before receiving a triggering instruction, the UAV 100 will respond to the triggering instruction and exit the flying or shooting mode.

The control module 220 is configured to respond to a triggering instruction, so as to control the UAV 100 to enter into an automatic shooting mode.

In this embodiment, the control module 220 controls the UAV 100 to enter into the automatic shooting mode after receiving a triggering instruction.

In some embodiments, an alarm system may be provided to send an alarm signal warning the user that the UAV 100 has entered into the automatic shooting mode. The alarm system may be a LED indicator provided on the UAV 100. For example, the LED indicator may be green when the UAV 100 is flying under normal condition, and be red and blink when the receiving module 210 receives a triggering instruction so that the UAV enters into the automatic shooting mode. The alarm system may also be an alarm light or an acoustic alarm different form the LED indicator provided on the UAV 100. When the alarm system is an alarm light, for example, it may be green when the UAV 100 is flying under normal condition, and be red and blink when the receiving module 210 receives a triggering instruction so that the UAV enters into the automatic shooting mode. When the alarm system is an acoustic alarm, for example, it may send an acoustic signal such as “preparing for shooting” when the receiving module 210 receives a triggering instruction so that the UAV enters into the automatic shooting mode.

It should be noted that the alarm system may be provided according to actual needs, and is not limited by the present disclosure.

The flight route generating module 230 is configured to generate flight route information corresponding to the predetermined shooting pattern under the automatic shooting mode.

In this embodiment, the flight route generating module 230 calculates and generates flight route information corresponding to the predetermined shooting pattern via a plurality of algorithms. The flight route information may include first flight route information and second flight route information. The first flight route information may include flight path (flight route), flight speed, time of flight of the UAV and the like. The second flight route information may include camera angle and the like.

As an example of the flight path generated by the flight route generating module 230, if the predetermined shooting pattern of the UAV is circling shooting and the radius of this circular motion is predetermined, the flight route generating module 230 may calculate and generate a circular motion path after the UAV 100 has received the triggering instruction. The circular motion path will center on the current position of the UAV 100 (or other desired location) and have a radius equal to the predetermined radius of the circular motion.

As an example of the flight speed generated by the flight route generating module 230, if the predetermined shooting pattern is shooting under acceleration and the acceleration of the UAV 100 is predetermined, the flight route generating module 230 may calculate the flight speed of the UAV 100 based on the predetermined acceleration after the UAV 100 has received the triggering instruction.

As an example of the camera angle generated by the flight route generating module 230, if the predetermined shooting pattern is shooting with the camera and the horizontal plane in a predetermined angle, the flight route generating module 230 may calculate in real-time the angle between the camera and the horizontal plane after the UAV 100 has received the triggering instruction, so as to control the position of the camera during shooting.

The control module 220 is also configured to control the UAV 100 to fly according to the flight route information, and control a video shooting apparatus provided on the UAV 100 to shoot according to the flight route information.

In this embodiment, since the first flight route information includes flight parameters of the UAV, such as flight path (flight route) and flight speed, the control module 220 may control the UAV 100 to fly according to the first flight route information. For example, the UAV 100 may monitor the position and the speed of the UAV 100 via GPS, optical flow sensor, radar, ultrasonic sensor, barometer, Inertial Measurement Unit (IMU) and the like, and the control module 100 may then control the UAV 10 to fly according to the first flight route information via control algorithms.

Moreover, since the second flight route information includes parameters of the video shooting apparatus, such as camera angle, the control module 220 may control the video shooting apparatus (for example, a camera) provided on the UAV 100 to shoot according to the second flight route information. For example, the video shooting apparatus may be fixedly connected to a platform or similar motion mechanisms. The control module 220 may bring the video shooting apparatus in motion by controlling the motion mechanism. An angle sensor may be provided on the motion mechanism to monitor the rotation angle of the camera. Based on the rotation angle, the control module 220 may then control the camera to shoot according to the second flight route information via control algorithms.

It should be noted that position information such as the angle of the camera angle may be set before the UAV 100 enters into the automatic shooting mode and be kept during shooting.

In some embodiments, when the UAV 100 is flying according to the flight route information and performs shooting, the user may send a first control instruction to the UAV 100, said first control instruction being input via a button provided on the remote control terminal or being input via acoustic control or gesture. The first control instruction may be an instruction which controls the UAV 100 to exit the automatic shooting mode. The control module 220 may control the UAV 100 to exit the automatic shooting mode and fly to a predetermined position or hover in the current position after the receiving module 210 has received the first control instruction. It should be noted that the predetermined position may be the starting position of the flight route corresponding to the first flight route information, or may be any other position predetermined by the user.

When the predetermined position is the starting position of the flight route corresponding to the first flight route information, the control module 220 may control the UAV 100 to return to the starting position according to the flight route. The control module 220 may also control the UAV 100 to return to the starting position according to a return flight route, said return flight route is generated by the flight route generating module 230 based on the starting position of the flight route corresponding to the first flight route information and the current position. For example, if the flight route corresponding to the first flight route information is an arc-shaped flight route, the flight route generating module 230 may generate a linear flight route from the current position back to the starting position, and the control module 220 may then control the UAV 100 to return rapidly to the starting position according to this linear flight route.

When the predetermined position is another position predetermined by the user, the flight route generating module 230 may generate a linear flight route from the current position to the predetermined position based on the current position and the predetermined position, and the control module 220 may then control the UAV 100 to fly rapidly to the predetermined position according to this linear flight route.

In some embodiments, when the UAV 100 is flying according to the flight route information and performs shooting, the user may send a second control instruction to the UAV 100 via a button provided on the remote control terminal or via acoustic control or gesture. The second control instruction may be any instruction other than the first control instruction described above, such as a hovering instruction, a landing instruction and the like. The control module 220 may control the UAV 100 to exit the automatic shooting mode and perform flight actions corresponding to the second control instruction after the receiving module 210 has received the second control instruction. In this way, the UAV 100 may exit the automatic shooting mode quickly when encountering an urgent accident, ensuring flight safety of the UAV 100.

In some embodiments, the UAV 100 may be provided with an obstacle avoidance apparatus. When the UAV 100 is flying according to the flight route information and performs shooting, the obstacle avoidance apparatus may collect obstacle information within a predetermined range. The control module 220 may control the UAV 100 to exit the automatic shooting mode and fly to a predetermined position or hover according to the obstacle information. In this way, the UAV 100 may exit the automatic shooting mode quickly when it is about to hit an obstacle, ensuring flight safety of the UAV 100. Here, the control module 220 controls the UAV 100 to fly to the predetermined position in the same way as in the above embodiments where the control module 220 controls the UAV 100 to fly to a predetermined position according to the first control instruction, and the description thereof is therefore omitted.

In some embodiments, when the UAV 100 completes the flight route corresponding to the first flight route information and flies to the destination position of this flight route, the control module 220 may further control the UAV 100 to fly to a predetermined position or hover at the destination position. It should be noted the control module 220 may control the UAV 100 to exit the automatic shooting mode firstly and then fly to the predetermined position when the UAV 100 arrives at the destination position of the flight route. Thus, the UAV 100 may stop shooting when flying from the destination position back to the predetermined position. The UAV 100 may also continue shooting when the UAV 100 arrives at the destination position. In this way, the UAV 100 may fly directly to the predetermined position under the automatic shooting mode and continues shooting when flying from the destination position back to the predetermined position. Here, the control module 220 controls the UAV 100 to fly to the predetermined position in the same way as in the above embodiments where the control module 220 controls the UAV 100 to fly to a predetermined position according to the first control instruction, and the description thereof is therefore omitted.

In some embodiments, the receiving module 210 may also receive the starting position and the destination position of the flight route corresponding to the first flight route information. The starting position and the destination position may be sent to the receiving module 210 after the flight route generating module 230 has generated the flight route information. The starting position and the destination position may also be detected by a GPS sensor provided on the UAV and sent to the receiving module 210 when the UAV arrives at the starting position or the destination position. The control module 220 may obtain the starting position and the destination position from the receiving module 210 and determine whether the starting position and the destination position are the same.

When the UAV 100 arrives at the destination position, if the starting position and the destination position are not the same (for example, when the UAV 100 flies along a straight line, the starting position and the destination position will not be the same), the control module 220 may control the UAV 100 to exit the automatic shooting mode and fly back to the starting position or hover at the destination position. When the UAV 100 arrives at the destination position, if the starting position and the destination position are the same (for example, when the UAV 100 flies circumferentially, the starting position and the destination position will be the same), the control module 220 may control the UAV 100 to exit the automatic shooting mode and hover at the destination position (i.e. the starting position).

### Embodiment 2

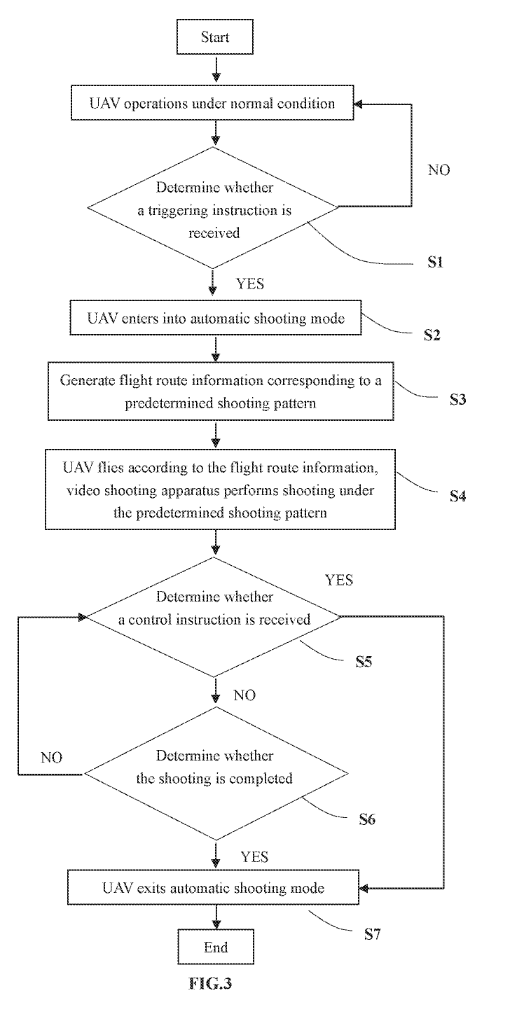

FIG. 3 is a flow chart of an exemplary method for controlling video shooting according to an embodiment of the present disclosure.

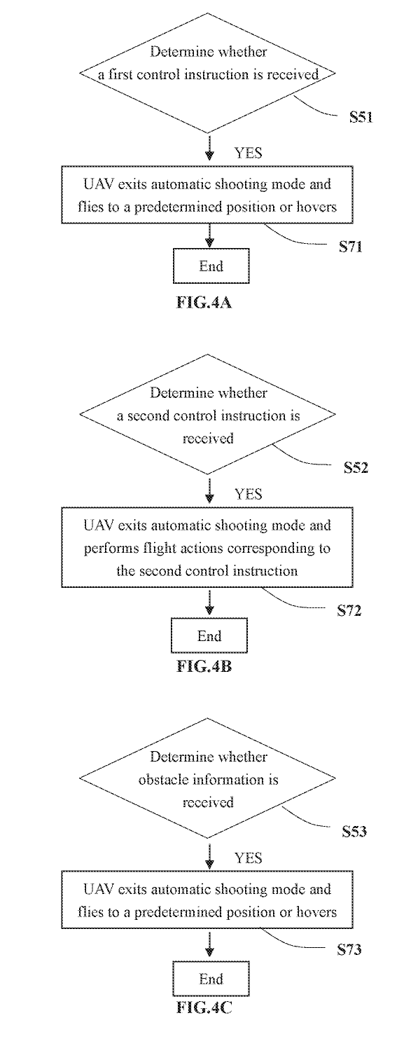

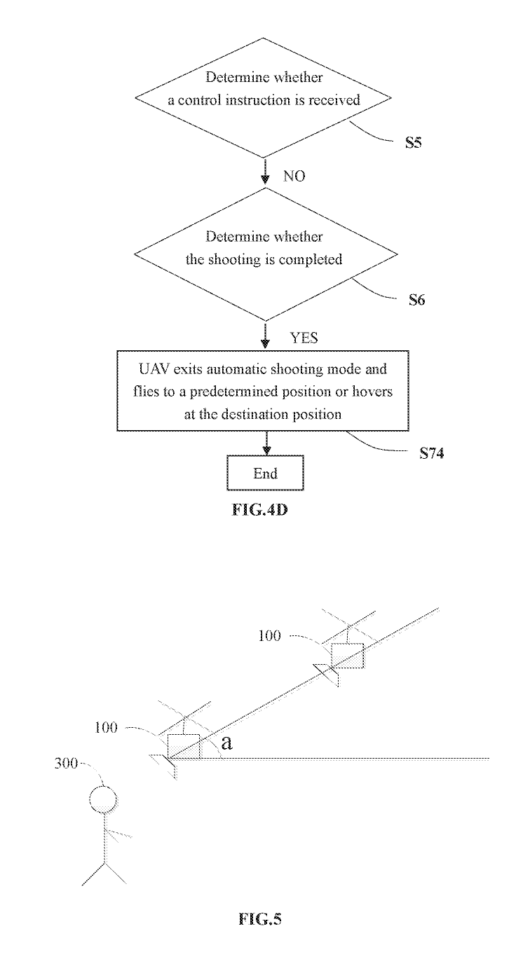

FIG. 4A-4D are flow charts showing several possible situations in an exemplary method for controlling video shooting according to an embodiment of the present disclosure.

In Step S1, it receives a triggering instruction.

In this embodiment, Step S1 may be performed by a receiving module 210.

The user may set in advance a predetermined shooting pattern for the UAV 100 via a remote control terminal, such as a UAV general purpose remote controller or a smartphone. The predetermined shooting pattern may be straight long shot, circling shooting around a point of interest, shooting under acceleration, shooting with the camera and the horizontal plane in a predetermined angle and the like. It should be noted that the predetermined shooting pattern may be set according to actual needs, and is not limited by the present disclosure.

Then, the user may send a triggering instruction to the UAV 100, which enables the UAV 100 to enter into an automatic shooting mode. In the automatic shooting mode, the UAV 100 will shoot according to the predetermined shooting pattern. The triggering instruction may be input by the user triggering a button on the remote control terminal, sending a voice command, performing a specific gesture. The input method of the triggering instruction is not limited by the present disclosure.

If the UAV 100 receives the triggering instruction, the method goes to Step S2; and if not, the UAV 100 will continue operating under normal condition.

In Step S2, it responds to the triggering instruction so that the UAV 100 enters into the automatic shooting mode accordingly.

In this embodiment, Step S2 may be performed by a control module 220.

The control module 220 controls the UAV 100 to enter into the automatic shooting mode after the receiving module has received the triggering instruction. Further, in some embodiments, an alarm system may be provided to send an alarm signal warning the user that the UAV 100 has entered into the automatic shooting mode. The alarm system may be a LED indicator provided on the UAV 100.

After the UAV has entered into the automatic shooting mode, the method goes to Step S3.

In Step S3, it generates flight route information corresponding to the predetermined shooting pattern under the automatic shooting mode.

In this embodiment, Step S3 may be performed by a flight route generating module 230.

The flight route generating module 230 may calculate and generate flight route information corresponding to the predetermined shooting pattern via a plurality of algorithms. The flight route information may include first flight route information and second flight route information. The first flight route information may include flight path (flight route), the flight speed, time of flight of the UAV 100 and the like. The second flight route information may include camera angle and the like. Then, the method goes to Step S4.

In Step S4, it controls the UAV 100 to fly according to the flight route information, and controls a video shooting apparatus provided on the UAV 100 to shoot according to the flight route information.

In this embodiment, Step S4 may be performed by the control module 220.

Since the first flight route information includes flight parameters of the UAV, such as flight path (flight route) and flight speed, and the second flight route information includes parameters of the video shooting apparatus, such as camera angle, Step S4 may further comprise the following step: Step S41, controlling the UAV 100 to fly according to the first flight route information; Step S42, controlling the video shooting apparatus (for example, a camera) provided on the UAV 100 to shoot according to the second flight route information. Then, the method goes to Step S5.

In Step S5, it determines whether a control instruction is received.

In this embodiment, Step S5 may be performed by the control module 220.

The UAV 100 determines in real-time whether it has received a control instruction when flying according to the flight route information and performs shooting. The control instruction may include a first control instruction, a second control instruction and obstacle information. The first control instruction may be an instruction which controls the UAV 100 to exit the automatic shooting mode. The second control instruction may be any instruction other than the first control instruction, such as hovering instruction, landing instruction and the like. The obstacle information may be obstacle information within a predetermined range collected by an obstacle avoidance apparatus provided on the UAV 100.

If the UAV has received the control instruction, the method goes to Step S7; and if not, the method goes to Step S6.

Referring to FIG. 4A, in one example, Step S5 may comprise a Step S51: determining whether a first control instruction is received. If yes, the method goes to Step S7; and if not, the method goes to Step S6. In Step S51, the first control instruction may be received by the receiving module 210.

Referring to FIG. 4B, in another example, Step S5 may also comprise a Step S52: determining whether a second control instruction is received. If yes, the method goes to Step S7; and if not, the method goes to Step S6. In Step S52, the second control instruction may be received by the receiving module 210.

Referring to FIG. 4C, in yet another example, Step S5 may also comprise a Step S53: determining whether an obstacle information is received. If yes, the method goes to Step S7; and if not, the method goes to Step S6. In Step S53, the obstacle information may be received by the receiving module 210. The obstacle information may be collected by an obstacle avoidance apparatus (for example, a distance sensor) provided on the UAV 100 and sent to the receiving module 210. The receiving module 210 may then send the obstacle information to the control module 220.

In Step S6, it determines whether the shooting is completed. If yes, the method goes to Step S7; and if not, the method goes to Step S4.

In this embodiment, Step S6 may be performed by the control module 220.

The control module 220 determines whether the shooting is completed based on whether the UAV 100 has flied to the destination position of the flight route corresponding to the first flight route information.

In Step S7, it controls the UAV to exit the automatic shooting mode.

In this embodiment, Step S7 may be performed by the control module 220.

Referring to FIG. 4A, when the receiving module 210 receives a first control instruction and sends it to the control module 220, it comprises a Step S71: controlling the UAV 100 to exit the automatic shooting mode and fly to a predetermined position or hover. Step S71 may be performed by the control module 220. When the predetermined position is the starting position of the flight route corresponding to the first flight route information, the control module 220 may control the UAV 100 to return to the starting position according to this flight route corresponding to the first flight route information. The control module 220 may also control the UAV 100 to return to the starting position according to a return flight route which is generated by the flight route generating module 230 based on the starting position of the flight route corresponding to the first flight route information and the current position. For example, if the flight route corresponding to the first flight route information is an arc-shaped flight route, the flight route generating module 230 may generate a linear flight route from the current position back to the starting position, and the control module 220 may then control the UAV 100 to return rapidly to the starting position according to this linear flight route.

Referring to FIG. 4B, when the receiving module 210 receives a second control instruction and sends it to the control module 220, it may comprise a Step S72: controlling the UAV 100 to exit the automatic shooting mode and perform flight actions corresponding to the second control instruction. Step S72 may be performed by the control module 220.

Referring to FIG. 4C, when the receiving module 210 receives the obstacle information and sends it to the control module 220, it may comprise a Step S73: controlling the UAV 100 to exit the automatic shooting mode and fly to a predetermined position or hover. Step S73 may be performed by the control module 220. Here, the control module 220 controls the UAV 100 to fly to the predetermined position in the same way as in the above embodiments where the control module 220 controls the UAV 100 to fly to a predetermined position according to the first control instruction, and the description thereof is therefore omitted.

Referring to FIG. 4D, when the UAV 100 arrives at the destination position of the flight route corresponding to the first flight route information, it may comprise a Step S74: controlling the UAV 100 to fly to a predetermined position or hover at the destination position. Step S74 may be performed by the control module 220. Here, the control module 220 controls the UAV 100 to fly to the predetermined position in the same way as in the above embodiments where the control module 220 controls the UAV 100 to fly to a predetermined position according to the first control instruction, and the description thereof is therefore omitted.

Further, in another example, Step S74 may comprise a Step S741: receiving the starting position and the destination position of the flight route corresponding to the first flight route information. When the UAV 100 arrives at the destination position, if the starting position and the destination position are not the same, the control module 220 may control the UAV 100 to exit the automatic shooting mode and fly back to the starting position or hover at the destination position. When the UAV 100 arrives at the destination position, if the starting position and the destination position are the same, the control module 220 may control the UAV 100 to exit the automatic shooting mode and hover at the destination position. The receiving module 210 may receive the starting position and the destination position and send it to the control module 220. The control module 220 may then control the UAV 100 to exit the automatic shooting mode and fly back to the starting position, or exit the automatic shooting mode and hover at the destination position.

It should be noted that the control module 220 may control the UAV 100 to exit the automatic shooting mode firstly and then fly to the predetermined position when the UAV 100 arrives at the destination position. In this way, the UAV 100 will stop shooting while flying from the destination position to the predetermined position. The UAV 100 may also choose not to exit the automatic shooting mode when the UAV 100 arrives at the destination position. In this way, the UAV 100 will fly directly to the predetermined position under the automatic shooting mode and continue shooting while flying from the destination position to the predetermined position.

FIG. 5 is a schematic diagram showing an exemplary video shooting scenario under straight long shot pattern according to an embodiment the present disclosure.

As shown in FIG. 5, in this example, in order to shoot a video of the user 300, the predetermined shooting pattern of the UAV 100 is set to straight long shot, the acceleration of the UAV during shooting is set to 0.5 m/s², and the elevation angle of the camera is set to a.

After receiving a triggering instruction, the UAV 100 enters into the automatic shooting mode. More specifically, the UAV moves away from the user 300 along an extension line with an angle of a, wherein the current position of the UAV is regarded as the starting position. The flight route generating module 230 calculates in real-time the flight speed of the UAV according to the predetermined acceleration. The flight speed of the UAV 100 will change from slow to fast, and the UAV will shoot for a predetermined period (i.e. the time of flight, for example, 10 s) until it stops shooting and hovers. Accordingly, it obtains a long shot video clip. In order to facilitate the user 300 to retrieve the UAV 100, the flight route generating module 230 will generate a return flight route from the current position back to the starting position of the flight route based on the starting position and the current position. For example, the flight route generating module 230 may generate a linear flight route from the current position back to the starting position. The UAV 100 will then return to the starting position according to this return flight route. The UAV may still be under the automatic shooting mode while returning to the starting position, so as to shoot another long shot video clip.

Further, in some embodiments, the user 300 may conduct shooting by pressing a shooting button of a mobile APP. The shooting button may be similar to that of the camera shutter. The user 300 may keep pressing the button so as to trigger the UAV 100 to enter into the automatic shooting mode. Then, the UAV 100 will fly away from the user under the predetermined straight long shot pattern. If the user releases the button during this time, it is considered that an accident might occur or the user might want to stop shooting. Therefore, the UAV will stop shooting and fly back to the starting position. If the user 300 presses the button again when the UAV is on its way back to the starting position, the UAV 100 will not respond to this triggering instruction. Instead, it will fly back to the starting position first, and then respond to a triggering instruction to enter into the automatic shooting mode again.

The present disclosure proposes a method and an apparatus for controlling video shooting and an unmanned aerial vehicle, which can automatically generate a shooting path according to a predetermined shooting pattern, ensuring the correctness of the camera angle and the flight route of the UAV, and avoiding incorrect manual operation and loss of shooting opportunity. Moreover, repeated manual operation is no longer needed since manual control of the flight route is omitted during video shooting. Therefore, the user can be more focused on shooting itself.

It should be understood that the apparatus and methods disclosed in the embodiments of the present disclosure can be implemented in other ways. The aforementioned embodiments are merely illustrative. For example, the flow charts and block diagrams in the figures show the possible architecture, function and operation of the apparatus, methods and computer program products according to the embodiments of the present disclosure. In this regard, each block of the flow charts or the block diagrams may represent a module, a program segment, or portion of the program code. The module, the program segment, or the portion of the program code includes one or more executable instructions for implementing predetermined logical function. It should also be noted that in some alternative embodiments, the function described in the block can also occur in a different order as described in the figures. For example, two consecutive blocks may be executed concurrently, or in reverse order, depending on relevant functions. It should also be noted that each block of the block diagrams and/or the flow charts block and block combinations of the block diagrams and/or the flow charts can be implemented by a dedicated hardware-based systems executing predetermined functions or operations, or by a combination of dedicated hardware and computer instructions.

Further, the function modules disclosed in embodiments of the present disclosure may be integrated to form a separate part. Alternatively, each module may be a separate part, or two or more modules may be integrated to form a separate part.

If the functions are implemented in form of software modules and sold or used as a standalone product, the functions can be stored in a computer readable storage medium. Based on this understanding, the technical solution of the present disclosure or its contribution to the prior art may be embodied in form of software product. The computer software product is stored in a storage medium, including several instructions which instruct a computer apparatus (may be a personal computer, a server, or a network equipment) to perform all or part of the steps of various embodiments of the present. The aforementioned storage media includes various mediums which can store a variety of program codes, such as U disk, removable hard disk, read only memory (ROM), random access memory (RAM), floppy disk or CD-ROM.

It should be noted that relational terms, such as first and second, are used solely to separate one entity or operation from another, and do not necessarily require or imply that such relationship or order actually exists between these entities or operations. Moreover, the term “comprising”, “including” or any variation thereof are intended to cover a non-exclusive inclusion, such that processes, methods, articles, or apparatus including a series of factors include not only those factors, but also include other factors not explicitly listed, or further include inherent factors for such processes, methods, articles or apparatus. Without more constraints, factors defined by the statement “includes a . . . ” do not exclude the presence of other factors included in the processes, methods, articles or apparatus.

Further, other embodiments will be apparent to those skilled in the art from consideration of the specification and practice of one or more embodiments of the disclosure disclosed herein. Any modifications, equivalent substitutions, improvements and the like within the spirit and principle of the present disclosure are intended to be included within the scope of the present disclosure. It is intended, therefore, that this disclosure and the examples herein be considered as exemplary only, with a true scope and spirit of the disclosure being indicated by the following claims.

What is claimed is:

1. An apparatus for controlling video shooting, wherein said apparatus comprises:
a receiving module configured to receive a triggering instruction;
a control module configured to control an unmanned aerial vehicle to enter into an automatic shooting mode in response to said triggering instruction; and
a flight route generating module configured to generate flight route information corresponding to a predetermined shooting pattern under said automatic shooting mode;
said control module is further configured to
control said unmanned aerial vehicle to fly according to said flight route information, and
control a video shooting apparatus provided on said unmanned aerial vehicle to shoot under said predetermined shooting pattern while said unmanned aerial vehicle is flying according to said flight route information.

2. The apparatus of claim 1, wherein said predetermined shooting pattern is selected from the group consisting of straight long shot, point of interest circling shooting, acceleration shooting, and preset angle shooting.

3. The apparatus of claim 1, wherein said flight route information comprises first flight route information having flight parameters of said unmanned aerial vehicle, and
said control module is further configured to control said unmanned aerial vehicle to fly according to said first flight route information.

4. The apparatus of claim 3, wherein said control module is further configured to, in response to said unmanned aerial vehicle flying to a destination position of a flight route corresponding to said first flight route information, control said unmanned aerial vehicle to hover at said destination position or fly to a predetermined position.

5. The apparatus of claim 3, wherein said receiving module is further configured to receive a starting position and a destination position of a flight route corresponding to said first light route information, and
when said unmanned aerial vehicle arrives at said destination position, said destination position and said starting position being different, said control module is further configured to
control said unmanned aerial vehicle to exit said automatic shooting mode; and
control said unmanned aerial vehicle to fly back to said starting position, or hover at said destination position.

6. The apparatus of claim 3, wherein said receiving module is further configured to receive a starting position and a destination position of a flight route corresponding to said first light route information, and
when said unmanned aerial vehicle arrives at said destination position, said destination position and said starting position being the same, said control module is further configured to
control said unmanned aerial vehicle to exit said automatic shooting mode; and
control said unmanned aerial vehicle to hover at said destination position.

7. The apparatus of claim 1, wherein said flight route information comprises second flight route information having parameters of said video shooting apparatus provided on said unmanned aerial vehicle, and
said control module is further configured to control said video shooting apparatus provided on said unmanned aerial vehicle to shoot according to said second flight route information.

8. The apparatus of claim 1, wherein said receiving module is further configured to receive a first control instruction, and
said control module is further configured to control said unmanned aerial vehicle to exit said automatic shooting mode and fly to a predetermined position or hover upon receipt of said first control instruction.

9. The apparatus of claim 1, wherein said receiving module is further configured to receive a second control instruction, and
said control module is further configured to control said unmanned aerial vehicle to exit said automatic shooting mode and perform a flight action in response to said second control instruction, said flight action being a landing action, or a hovering action.

10. The apparatus of claim 1, wherein said receiving module is further configured to receive obstacle information within a predetermined range collected by said unmanned aerial vehicle, and
said control module is further configured to control said unmanned aerial vehicle to exit said automatic shooting mode and fly to a predetermined position or hover according to said obstacle information.

11. A method for controlling video shooting, wherein said method comprises:
receiving a triggering instruction;
controlling an unmanned aerial vehicle to enter into an automatic shooting mode in response to said triggering instruction;
generating flight route information corresponding to a predetermined shooting pattern under said automatic shooting mode;
controlling said unmanned aerial vehicle to fly according to said flight route information, and
controlling a video shooting apparatus provided on said unmanned aerial vehicle to shoot under said predetermined shooting pattern while said unmanned aerial vehicle is flying according to said flight route information.

12. The method of claim 11, wherein said flight route information comprises first flight route information having flight parameters of said unmanned aerial vehicle, and
said step of controlling said unmanned aerial vehicle to fly further comprises controlling said unmanned aerial vehicle to fly according to said first flight route information.

13. The method of claim 12, wherein said step of controlling said unmanned aerial vehicle to fly further comprises:
controlling said unmanned aerial vehicle to fly to a predetermined position or to hover at a destination position of a flight route corresponding to said first flight route information, when said unmanned aerial vehicle arrives at said destination position.

14. The method of claim 12, wherein said step of controlling said unmanned aerial vehicle to fly further comprises:
obtaining a starting position and a destination position of a flight route corresponding to said first light route information, and
controlling said unmanned aerial vehicle to exit said automatic shooting mode and fly to said starting position or hover at said destination position, when said unmanned aerial vehicle arrives at said destination position, said destination position being different from said starting position.

15. The method of claim 12, wherein said step of controlling said unmanned aerial vehicle to fly further comprises:
obtaining a starting position and a destination position of a flight route corresponding to said first light route information, and
controlling said unmanned aerial vehicle to exit said automatic shooting mode and hover at said destination position, when said unmanned aerial vehicle arrives at said destination position, said destination position being the same as said starting position.

16. The method of claim 11, wherein said flight route information comprises second flight route information having parameters of said video shooting apparatus provided on said unmanned aerial vehicle, and said step of controlling said video shooting apparatus further comprises:
controlling said video shooting apparatus provided on said unmanned aerial vehicle to shoot according to said second flight route information.

17. The method of claim 11, wherein said method further comprises:
receiving a first control instruction, and
controlling said unmanned aerial vehicle to exit said automatic shooting mode and fly to a predetermined position or hover upon receipt of said first control instruction.

18. The method of claim 11, wherein said method further comprises:
receiving a second control instruction, and
controlling said unmanned aerial vehicle to exit said automatic shooting mode and perform a flight action in response to said second control instruction, said flight action being a landing action or a hovering action.

19. The method of claim 11, wherein said method further comprises:
receiving obstacle information within a predetermined range collected by said unmanned aerial vehicle, and
controlling said unmanned aerial vehicle to exit said automatic shooting mode and fly to a predetermined position or hover according to said obstacle information.

20. An unmanned aerial vehicle, wherein said unmanned aerial vehicle comprises:
a memory;
a processor; and
an apparatus for controlling video shooting, wherein said apparatus for controlling video shooting is loaded into said memory and comprises one or more software function modules executed by said processor, wherein said apparatus for controlling video shooting comprises:
a receiving module configured to receive a triggering instruction;
a control module configured to control said unmanned aerial vehicle to enter into an automatic shooting mode in response to said triggering instruction; and
a flight route generating module configured to generate flight route information corresponding to a predetermined shooting pattern under said automatic shooting mode;
said control module is further configured to control said unmanned aerial vehicle to fly according to said flight route information, and control a video shooting apparatus provided on said unmanned aerial vehicle to shoot under said predetermined shooting pattern while said unmanned aerial vehicle is flying according to said flight route information.
